(19) United States
(12) Patent Application Publication
(10) Pub. No.: US 2010/0233029 A1
(43) Pub. Date: Sep. 16, 2010

(54) COMPENSATED MEMBRANE CAPACITIVE BIO-CHEMICAL SENSOR

(75) Inventors: Arun Majumdar, Orinda, CA (US); Si-Hyung Lim, Albany, CA (US)

Correspondence Address: BUCHANAN, INGERSOLL & ROONEY PC, POST OFFICE BOX 1404, ALEXANDRIA, VA, 22313-1404, US

(73) Assignee: THE REGENTS OF THE UNIVERSITY OF CALIFORNIA, Oakland, CA (US)

(21) Appl. No.: 12/440,990

(22) PCT Filed: Sep. 12, 2007
(86) PCT No.: PCT/US07/19832

§ 371 Date: May 24, 2010

Related U.S. Application Data
(60) Provisional application No. 60/844,147, filed on Sep. 12, 2006.

(51) Int. Cl. G01N 30/00; C23F 1/00

(52) U.S. Cl. 422/69; 216/13

(57) ABSTRACT

A sensor having a membrane, which is adapted to deflect in response to a change in surface stress. The membrane has a first and a second surface, which includes a first coating layer on the first surface of the membrane, and a second coating layer on the second surface of the membrane. The first coating layer is adapted to couple one or more probe molecules with the membrane.

### CROSS REFERENCE TO RELATED APPLICATIONS

This application claims priority to U.S. Provisional Patent Application Ser. No. 60/844,147 filed on Sep. 12, 2006, which is incorporated herein by this reference in its entirety.

### GOVERNMENT INTEREST

This application was funded by a grant from the National Science Foundation, grant number EEC0425914. The United States Government has certain rights in the invention.

### BACKGROUND

A membrane type sensor, where a layer on the membrane is to couple probe molecules, can deflect in response to a change in surface stress. The surface stress is generated when target molecules react with the probe molecules. In addition, it can be appreciated that surface stress sensors using micro machined silicon cantilevers have been demonstrated in chemical and biological sensing. However, the design, geometry and performance of these sensors can be limited by the high stiffness of the silicon-based materials used in their fabrication. Accordingly, it would be desirable for a sensor design, which minimizes undesired thermal and chemical absorption responses.

### BRIEF DESCRIPTION OF THE DRAWINGS

FIG. 1 is a circular membrane coated with a thin film coating layer in accordance with one embodiment.

FIG. 2 is a cross-sectional view of FIG. 1 along the line A-A′ without a lower thin film coating layer.

FIG. 3 is a cross-sectional view of FIG. 1 along the line A-A′ with a lower thin film coating layer, which compensates for undesired thermal and chemical responses.

FIG. 4 is a table of material and model properties.

FIG. 5 is a plot of FEM simulation results for a compensated membrane capacitive bio-chemical sensor (e.g. rₚ=200 μm, r_{g}=160 μm, tₚ=0.5 μm, t_{g}=30 nm, Δσ=10 mJ/m2) in accordance with an embodiment.

FIG. 6 is a graph of coating layer coverage optimization with a Δσ=10 mJ/m2.

FIG. 7 is a table of FEM simulation result summaries.

FIG. 8A is a flow chart of the fabrication process for a compensated membrane bio-sensor in accordance with one embodiment.

FIG. 8B is a flow chart of the fabrication process for a compensated membrane bio-sensor in accordance with another embodiment.

FIGS. 9A and B are capacitive membrane sensors in accordance with another embodiment.

FIGS. 10A-D are a series of diagrams showing a sensing platform for a capacitive membrane sensor.

FIGS. 11A-C is a series of graphs depicting experimental results including temperature response (FIG. 11A), water vapor response (FIG. 11B), and isopropyl alcohol response (FIG. 11C) in accordance with one embodiment.

FIG. 12 is a modified capacitive membrane sensor design in accordance with a further embodiment.

FIG. 13 is a chemical sensing board in accordance with a further embodiment.

### DETAILED DESCRIPTION

In conventional membrane sensor design, only one side thin film coating layer like gold is used to accommodate the probe molecules (Srinath Satyanarayana et al., “Parylene micro membrane capacitive sensor array for chemical and biological sensing,” Sensors and Actuators B, 2005). However, the strain mismatch between membrane and the thin film coating materials can generate undesired structural deformation for thermal environment change and chemical absorption into the membrane.

To compensate for those undesired sensor responses in a membrane-type bio-chemical sensor, in accordance with one embodiment, the sensor 10 comprises putting another coating layer on the bottom of the membrane structure, such that those undesired sensor responses can be self compensated. In addition, it can be appreciated that the new sensor 10 design can be easily fabricated using bulk and surface micromachining techniques. The great reduction of the undesired thermal response also provides the possibility to remove the substrate temperature controller in a usual bio-chemical sensor platform. In addition, in a portable or stand alone product, this unique design (i.e., sensor 10) can greatly reduce power consumption.

In accordance with one embodiment, a sensor 10 comprises: a membrane 20 adapted to deflect in response to a change in surface stress, the membrane 20 having a first surface 22 and a second surface 24; a first coating layer 30 on the first surface 22 of the membrane 20, the first coating layer 30 adapted to couple one or more probe molecules 50 with the membrane 20; and a second coating layer 40 on the second surface 24 of the membrane 20.

In accordance with a further embodiment, a method of fabricating a sensor 10 comprises: coating a quartz wafer with platinum on a first side; evaporating a first gold thin film to form a bottom electrode; coating a photoresist to form a spacer, wherein the spacer is adapted to allow for movement of a membrane structure; evaporating a second thin gold film to form an upper electrode; coating the upper electrode with parylene to form an electrical contact between the upper electrode and an aluminum contact pad; sputtering aluminum to form the aluminum contact pad; evaporating a third gold thin film for a receptor coating layer; and etching the parylene covered portions to form release holes.

In accordance with another embodiment, a method of fabricating a sensor 10 comprises: forming a cavity for a membrane by wet etching a substrate; forming a bottom electrode comprising a chromium layer and a gold layer on a bottom portion of the cavity; filing the bottom portion of the cavity with a sacrificial photoresist layer; depositing a first gold layer on an upper surface of the sacrificial photoresist layer; depositing a membrane layer on the gold layer; depositing a second gold layer on the membrane layer; and etching the sacrificial photoresist layer to release the sensor.

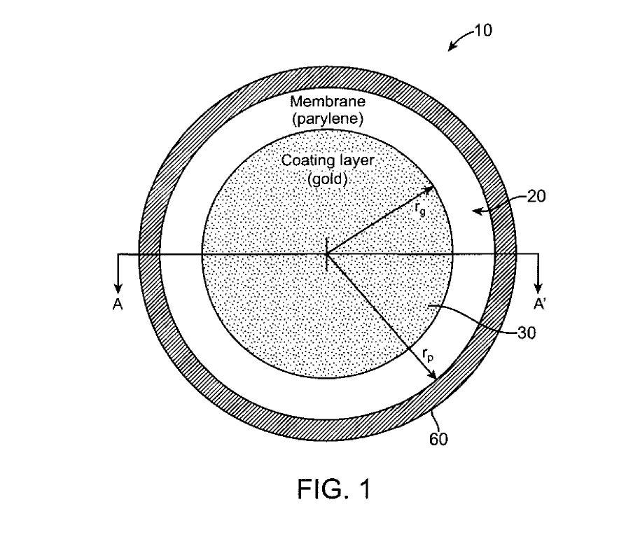

FIG. 1 shows a circular membrane 20 coated with a thin film coating layer 30. As shown in FIG. 1, a parylene circular membrane 20 can be coated 30 with a thin layer of gold or other suitable metal, metal oxide or material.

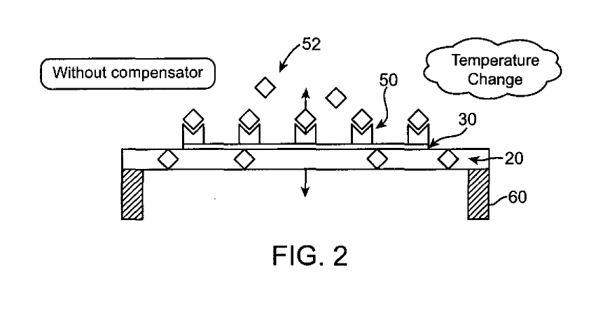

FIG. 2 shows a cross-sectional view of FIG. 1 along the line A-A′ without a lower thin film coating layer. As shown in FIG. 2, the sensor 10 includes a membrane 20 having an upper or first coating layer 30 on the first surface 22 of the membrane 20. The first coating layer 30 adapted to couple one or more probe molecules 50 with the membrane 20. In accordance with an embodiment, the membrane 20 is attached to a substrate 60. The one or more probe molecules 50 interact with associated target molecules, such that the sensor 10 exhibits a chemical or physical change upon interacting with the associated target molecules 52.

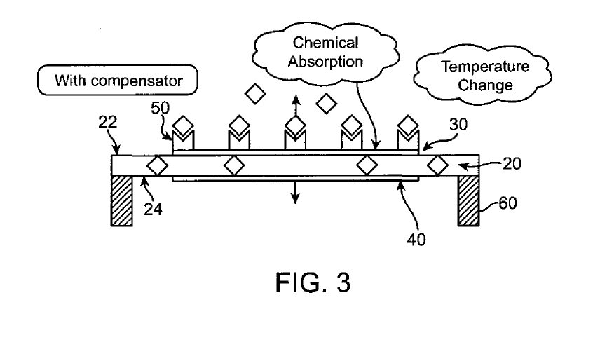

FIG. 3 shows a cross-sectional view of FIG. 1 along the line A-A′ with a lower thin film coating layer 40, which compensates for undesired thermal and chemical responses. As shown in FIG. 3, in accordance with one embodiment, the compensated design has a special configuration having a double side coating region. Ideally, the sensor 10 does not deform in response to environment temperature change and chemical absorption into the membrane layer 20. In addition, the mismatch strain between the lower coating layer 40 and membrane layer 20 is the same as that between the upper coating layer 30 and membrane layer 20. It can be appreciated that to get high sensitivity to surface stress change, the material selection and physical dimensions can be optimized. In accordance with an embodiment, the membrane 20 is preferably a polymer, and more preferably, the polymer is parylene.

In accordance with an embodiment, the membrane 20 includes a first portion fixed to a substrate 60 and a second portion fixed to a different portion of the substrate 60. The covered portion of the first and second surfaces 22, 24 is preferably between about 60% and about 100% of each surface, and more preferably, the covered portion of the first and second surfaces 22, 24 are between about 80% and about 90% of each surface.

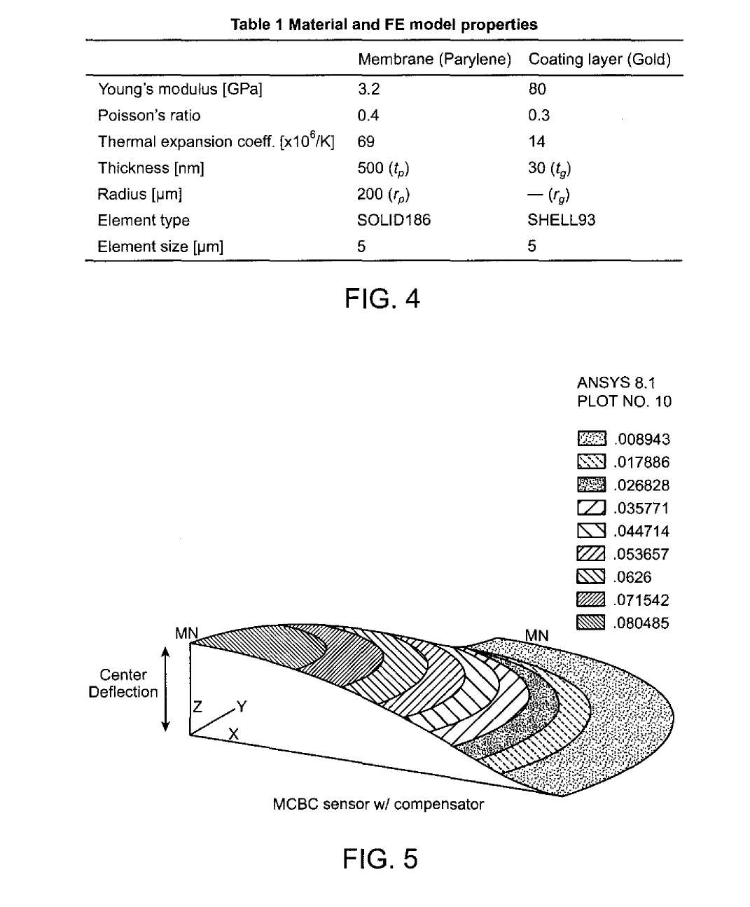

FIGS. 4 and 5 show FE (finite element) simulation results (using a commercial software ANSYS) for various gold coating coverage over fixed membrane size at surface stress change Δσ=10 mJ/m2. FIG. 4 (i.e., Table 1) shows the material properties, structural parameters, and FE model used in the FE simulation. FIG. 5 shows FEM (finite element method) simulation results for compensated membrane capacitive bio-chemical sensor (e.g. rₚ=200 μm, r_{g}=160 μm, tₚ=0.5 μm, t_{g}=30 nm, Δσ=10 mJ/m2).

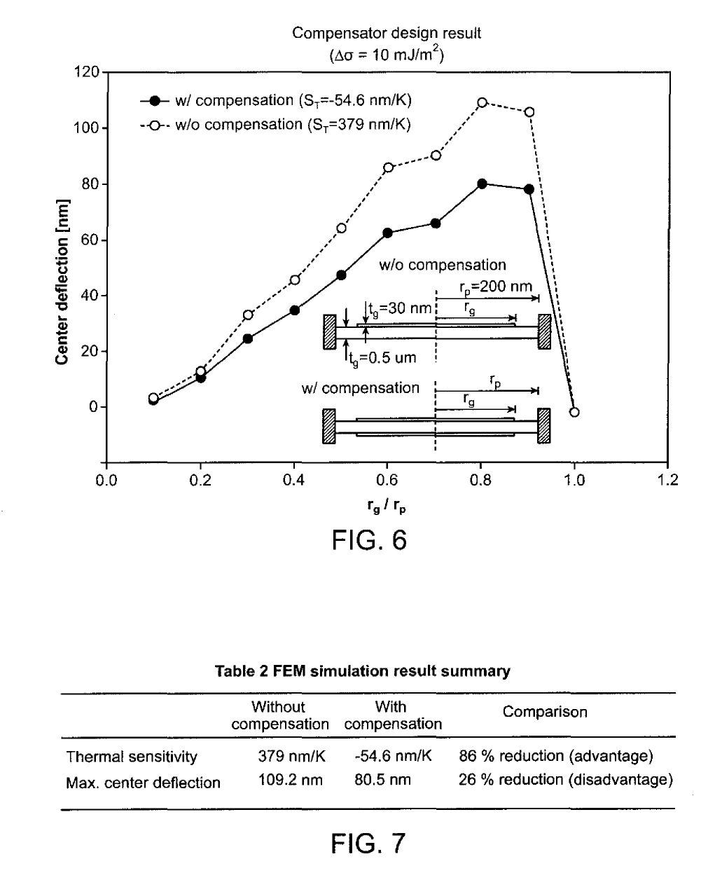

FIG. 6 shows a graph of coating layer coverage optimization with a Δσ=10 mJ/m2. As shown in FIG. 6, the maximum membrane center deflection can be achieved for gold coating coverage ratio 0.8˜0.9. Although there is 28% reduction in the sensor sensitivity, the undesired thermal sensitivity has 86% reduction as shown in FIG. 7 (i.e., Table 2). Therefore, the double side coated design can provide for thermal compensation, and the advantages in case of the undesired chemical absorption can be easily demonstrated in a similar way.

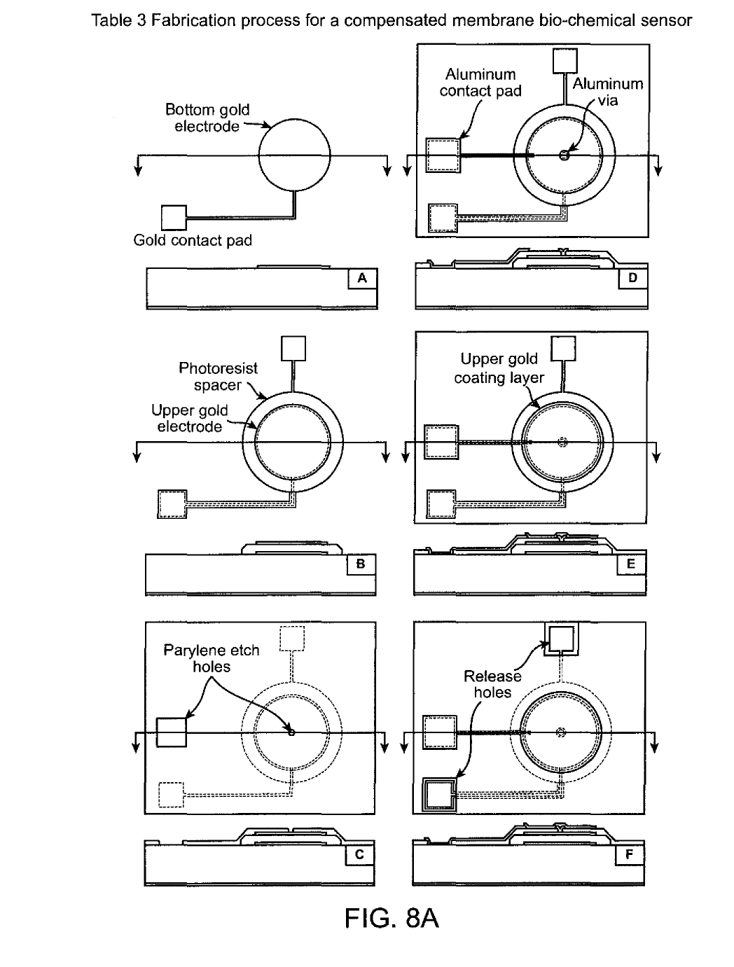

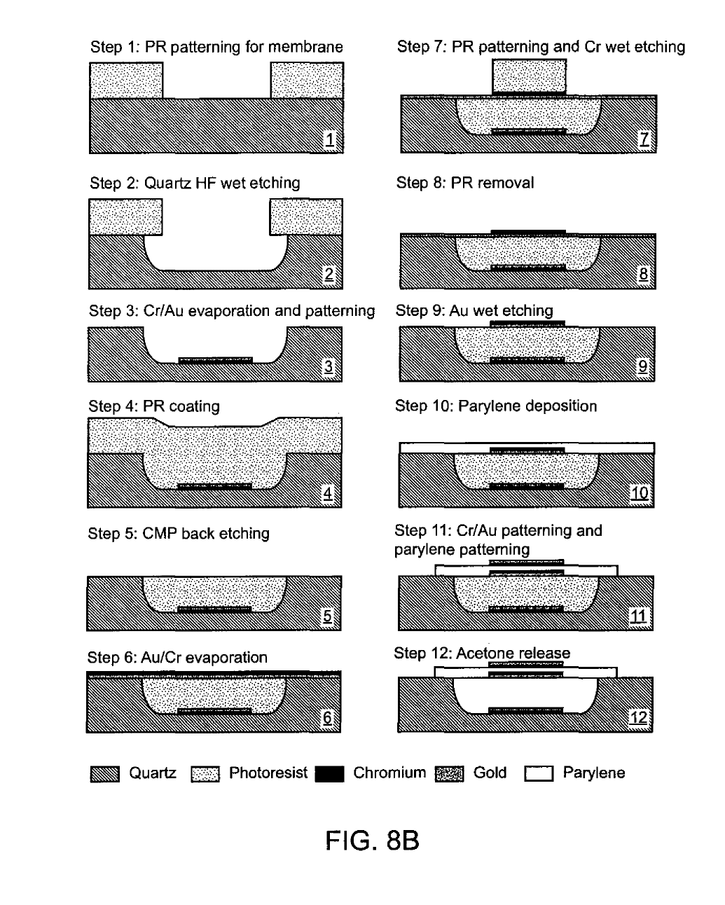

In accordance with one embodiment, the proposed compensated design or sensor 10 can be fabricated using surface micromachining techniques. FIG. 8A (i.e. Table 3) shows the overall fabrication steps. The fabrication process starts from a quartz wafer coated with platinum on the backside. First, gold thin film is evaporated and patterned to form a bottom electrode (A). Second, photoresist is coated and patterned to form a spacer for the free movement of a membrane structure, and then gold thin film is evaporated and patterned to form an upper electrode (B). Third, parylene is coated and patterned to form an electrical contact between upper gold electrode layer and an aluminum contact pad (C). Fourth, aluminum is sputtered and patterned (D). Fifth, a gold thin film is evaporated and patterned to for a receptor coating layer (E). Finally, parylene covered portions are etched to form release holes, and then overall device or sensor is immersed in acetone and released by critical point dryer (F).

In accordance with another embodiment, the proposed compensated design or sensor 10 can be fabricated using bulk and surface micromachining techniques. FIG. 8B (i.e., Table 4) shows the overall fabrication steps. The major fabrication steps can be summarized as follows. First, the cavity for membrane operation is formed by HF wet etching of a quartz substrate. Second, after making a bottom electrode the cavity is filled with photoresist and be etched back by chemical mechanical polishing (CMP). Third, the bottom gold coating layer is formed by sequential wet etching of chromium and gold layers. It will be used for 1) upper electrode for capacitive sensing and 2) a compensator to remove undesired sensor responses. Fourth, parylene membrane and upper gold coating layer are formed. To provide access to the sacrificial photoresist layer, parylene is patterned by oxygen plasma. Finally, the structure or sensor is released by etching the photoresist sacrificial layer.

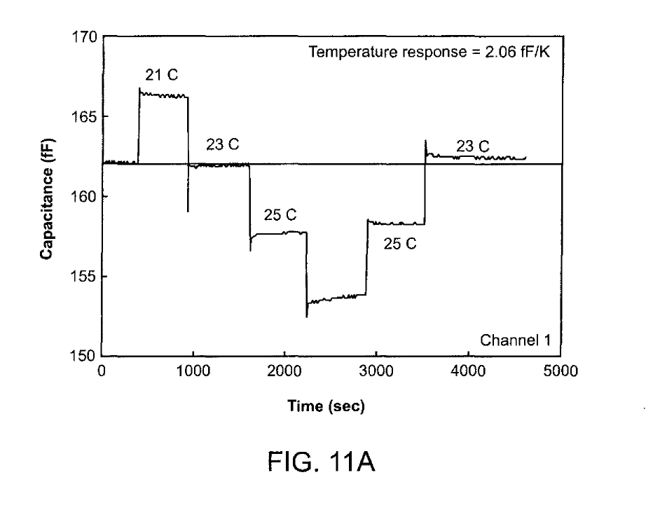

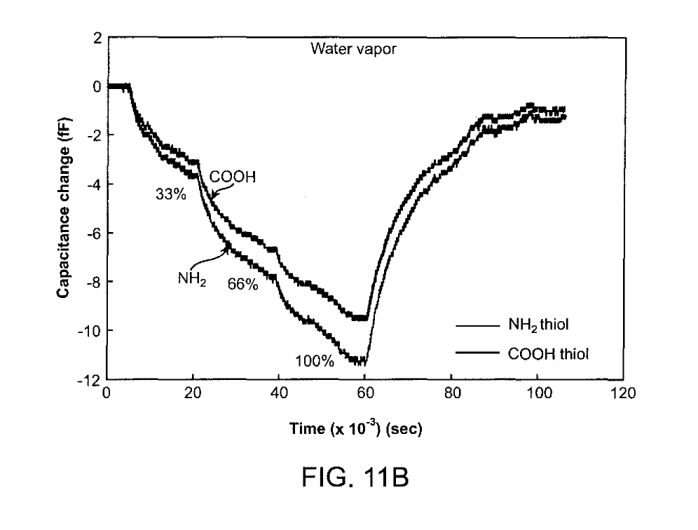

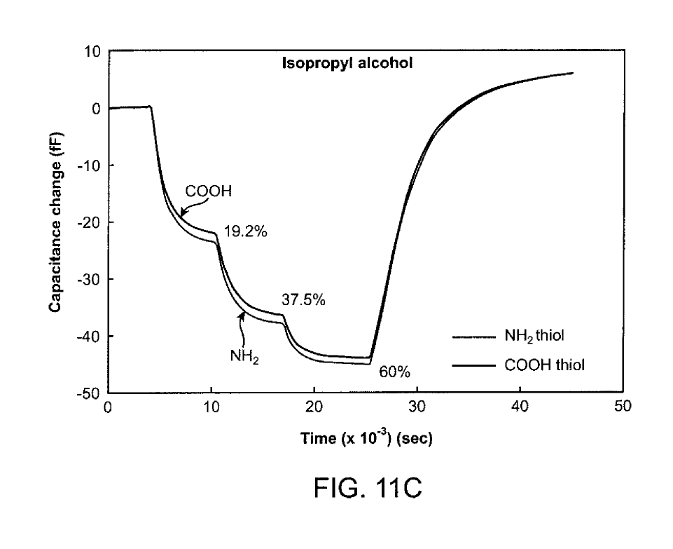

In addition, it can be appreciated that chemical sensing experiments have been demonstrated using a capacitive surface stress-based chemo-mechanical sensor, alkanethiol sensor coating layers, and a dedicated capacitance measurement board. In order to minimize undesired thermal and chemical absorption responses, a thermal and chemical absorption compensation design as shown in FIGS. 3, 8, and 12. In addition, the sensor 10 can include a dedicated capacitance measurement board with sub-femto farad accuracy and an in-built temperature controlled stage. Chemical sensing experiments using miniaturized sensing platform are shown in FIG. 11A-11C using the fabricated sensor array and alkanethiol sensor coating layers in accordance with an embodiment.

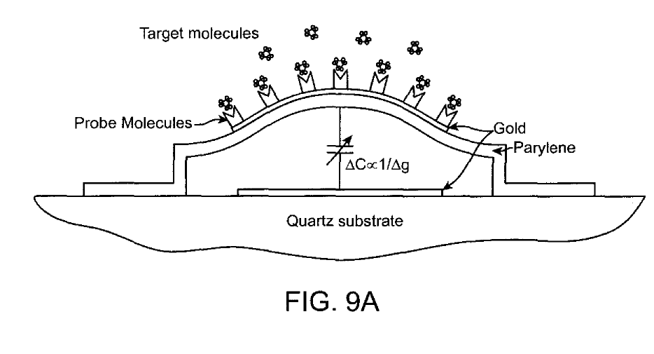

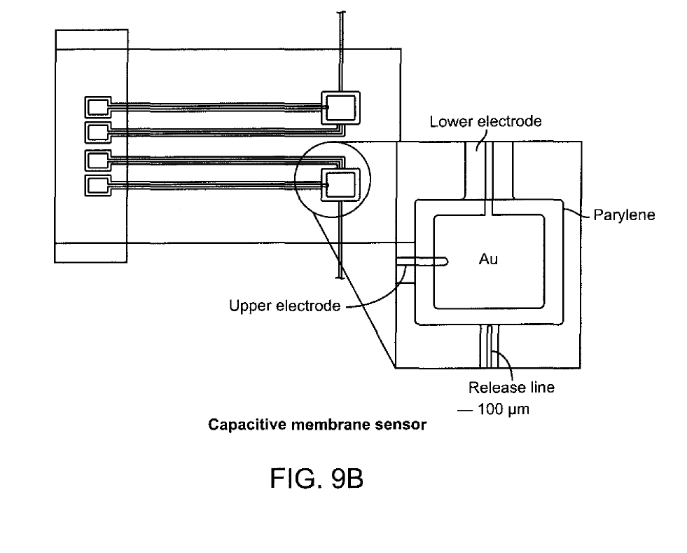

FIGS. 9A and 9B show a parylene micro-membrane surface stress sensor array using capacitive signal readout for chemical sensing applications. The micro-membrane sensor exploits the low elasticity modulus, better chemical resistance and biocompatibility of parylene when compared to the silicon-based materials used in traditional microfabrication. When selective chemical/biological reactions occur between the target and probe molecules on the sensor surface, the changes in the intermolecular forces induce a surface stress change which causes the membrane to change curvature and deflect as shown in FIGS. 9A and B. The sensor deflection changes the effective gap between the two electrodes and changes the capacitance.

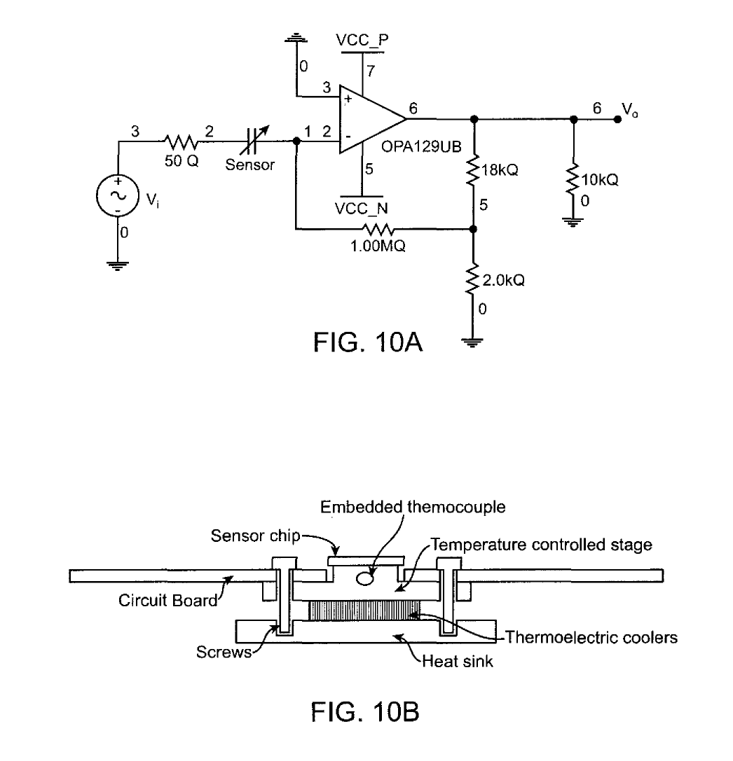

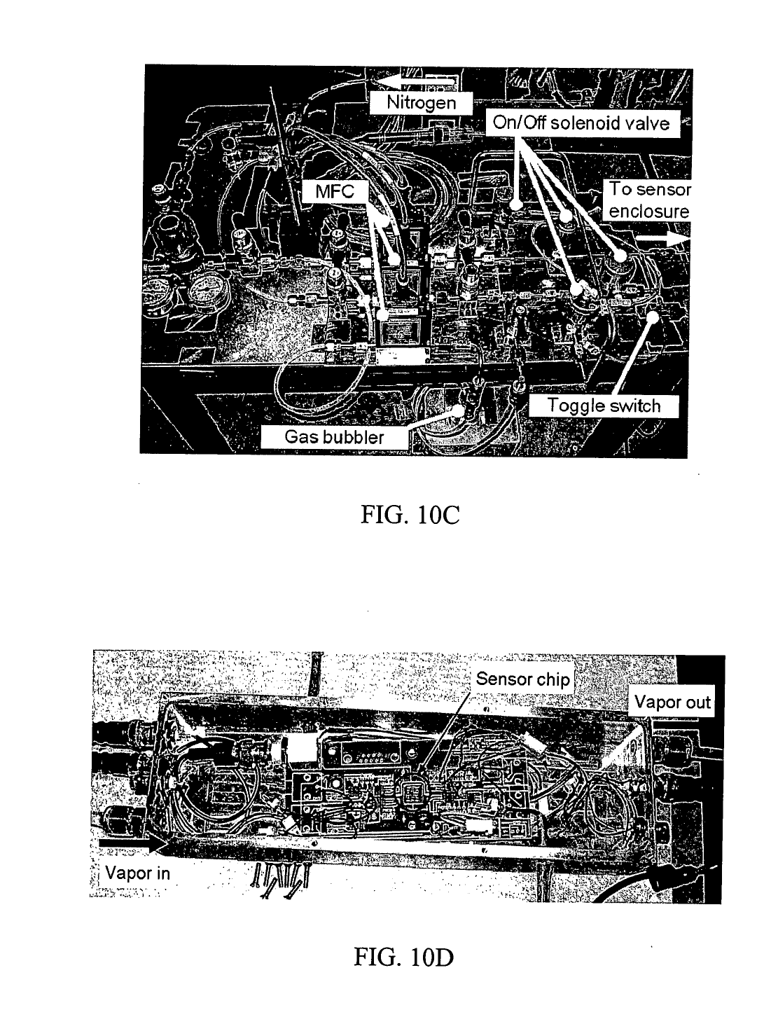

FIGS. 10A-D shows sensing platform including a single-ended capacitance measurement circuit (A), on-board temperature control system (B), target vapor generation/control system (C), and integrated chemical sensing chamber (D). In accordance with an embodiment as shown in FIG. 10B, the on-board temperature control system can include a circuit board, a sensor chip, an embedded thermocouple, a temperature controlled stage, thermoelectric coolers, and a heat sink.

In accordance with one embodiment, temperature response for each of the sensors used in the chemical sensing experiment was measured to test the proper release of the sensor membrane (FIG. 11A). Two different alkanethiol coatings [11 Mercapto 1 undecanoicacid (WA) SH-(CH2)10-COOH and 11 Amino 1 undecanethiol (AOT) SH-(CH2)11-NH2] were used as sensing layers in the multiplexed measurement. Sensor response to example sensing targets like water and IPA (Isopropyl alcohol) vapors at different concentrations were measured (FIGS. 11B and 11C). The results for experiments with IPA (Isopropyl alcohol) and water vapor showed that based on the measurement noise the sensor resolution was estimated to be approximately 30 ppm (parts-per-million) and approximately 200 ppm (parts-per-million) for IPA (Isopropyl alcohol) and water vapor, respectively.

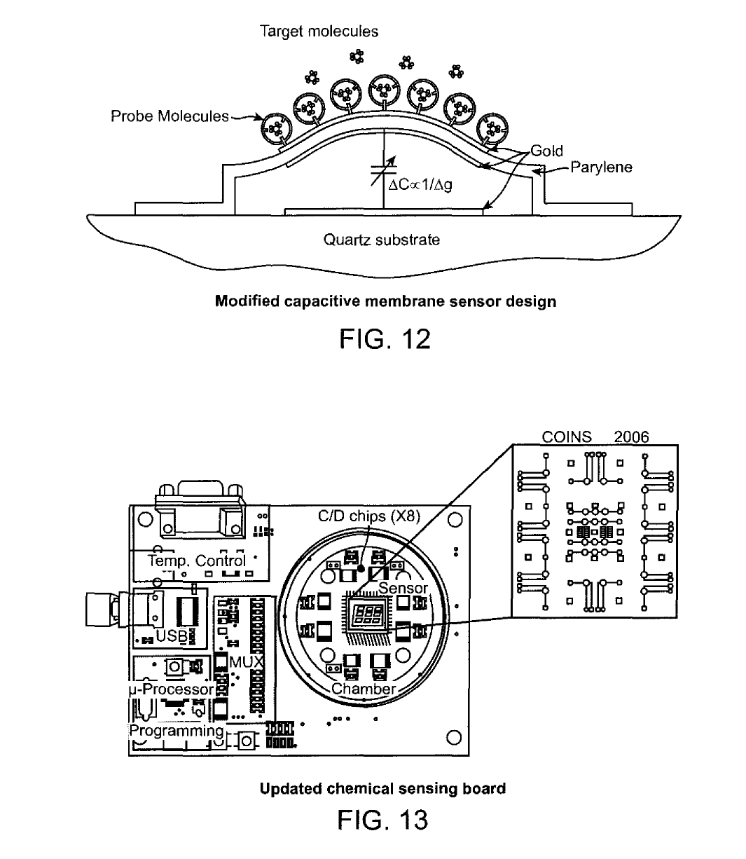

In addition, the experimental results for simple test vapors showed the strain mismatch between membrane and the thin film coating materials can generate undesired structural deformation for thermal environment change, and chemical absorption into the membrane. However, to compensate for those undesired sensor responses in a membrane-type bio-chemical sensor, in accordance with one embodiment, a sensor design as shown in FIG. 12, which comprises putting another coating layer on the bottom of the membrane structure, such that those undesired sensor responses can be self compensated. The reduction of the undesired thermal response provides the possibility to remove the substrate temperature controller in a usual bio-chemical sensor platform. It can be appreciated that in a portable or stand alone product, this unique design will greatly reduce power consumption.

FIG. 13 shows a chemical sensing board in accordance with another embodiment. As shown in FIG. 13, the chemical sensing board includes a temperature control device, a serial bus or interface device, such as a USB port (Universal Serial Bus), a micro-processor and programming component, a multiplexer (MUX), C/D chips (i.e., XP), and a chamber with a sensor.

It will be understood that the foregoing description is of the preferred embodiments, and is, therefore, merely representative of the article and methods of manufacturing the same. It can be appreciated that variations and modifications of the different embodiments in light of the above teachings will be readily apparent to those skilled in the art. Accordingly, the exemplary embodiments, as well as alternative embodiments, may be made without departing from the spirit and scope of the articles and methods as set forth in the attached claims.

1. A sensor comprising:
a membrane adapted to deflect in response to a change in surface stress, the membrane having a first surface and a second surface;
a first coating layer on the first surface of the membrane, the first coating layer adapted to couple one or more probe molecules with the membrane; and
a second coating layer on the second surface of the membrane.

2. The sensor of claim 1, wherein the first and second coating layers compensate for undesired thermal and chemical responses of the sensor.

3. The sensor of claim 1, further comprising one or more probe molecules coupled with the first coating layer of the membrane.

4. The sensor of claim 1, wherein the first and second coating layers are gold.

5. The sensor of claim 1, wherein the membrane includes a first portion fixed to a substrate and a second portion fixed to a different portion of the substrate.

6. The sensor of claim 1, further comprising one or more probe molecules for interacting with an associated target molecules, and wherein the sensor exhibits a chemical or physical change upon interacting with the associated target molecules.

7.-11. (canceled)

12. A method of fabricating a sensor comprising:
coating a quartz wafer with platinum on a first side;
evaporating a first gold thin film to form a bottom electrode;
coating a photoresist to form a spacer, wherein the spacer is adapted to allow for movement of a membrane structure;
evaporating a second thin gold film to form an upper electrode;
coating the upper electrode with parylene to form an electrical contact between the upper electrode and an aluminum contact pad;
sputtering aluminum to form the aluminum contact pad;
evaporating a third gold thin film for a receptor coating layer; and
etching the parylene covered portions to form release holes.

13. The method of claim 12, further comprising immersing the sensor in acetone.

14. The method of claim 13, further comprising releasing the sensor with a critical point dryer.

15. The method of claim 12, further comprising patterning the first gold thin film to form the bottom electrode.

16. The method of claim 12, further comprising patterning the photoresist to form the spacer, wherein the spacer is adapted to allow for movement of a membrane structure.

17. The method of claim 12, further comprising patterning the second thin gold film to form the upper electrode.

18. The method of claim 12, further comprising patterning the parylene to form the electrical contact between the upper electrode and the aluminum contact pad.

19. The method of claim 12, further comprising patterning the aluminum to form the aluminum contact pad.

20. The method of claim 12, further comprising patterning the third gold thin film for the receptor coating layer.

21. A method of fabricating a sensor comprising:
forming a cavity for a membrane by wet etching a substrate;
forming a bottom electrode comprising a chromium layer and a gold layer on a bottom portion of the cavity;
filing the bottom portion of the cavity with a sacrificial photoresist layer;
depositing a first gold layer on an upper surface of the sacrificial photoresist layer;
depositing a membrane layer on the gold layer;
depositing a second gold layer on the membrane layer; and
etching the sacrificial photoresist layer to release the sensor.

22. (canceled)

23. The method of claim 21, further comprising etching a portion of the sacrificial photoresist with a chemical mechanical polishing (CMP) to form the upper surface of the sacrificial photoresist layer.

24. The method of claim 21, wherein the bottom electrode is formed by sequential wet etching of the chromium layer and the gold layer on the bottom portion of the cavity.

25. The method of claim 21, further comprising:
depositing the first gold layer by evaporation of a chromium layer and a gold layer on an upper surface of the sacrificial photoresist;
patterning a photoresist on the first gold layer and wet etching the chromium layer;
removing the photoresist from the first gold layer; and
wet etching the first gold layer.

26.-28. (canceled)

29. The method of claim 21, wherein depositing a second gold layer on the membrane layer further comprises:
patterning of a second chromium layer and the second gold layer; and
patterning the membrane layer with oxygen plasma to provide access to the sacrificial photoresist layer.

30.-33. (canceled)
